(19) United States
(12) Patent Application Publication
(10) Pub. No.: US 2003/0001297 A1
(43) Pub. Date: Jan. 2, 2003

(54) Manufacturing method for optical connector ferrule and forming mold used in the manufacturing method

(76) Inventors: Katsuki Suematsu, Tokyo (JP); Yasushi Kihara, Tokyo (JP); Takashi Shigematsu, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/041,685

(22) Filed: Oct. 19, 2001

(30) Foreign Application Priority Data
May 29, 2001 (JP) 2001-161131

(51) Int. Cl. B29D 11/00

(52) U.S. Cl. 264/1.25; 425/577

(57) ABSTRACT

A method for manufacturing an optical connector ferrule according to the present invention is a method for manufacturing an optical connector ferrule where a plurality of fiber holes are arranged between two guide pin holes, wherein melted material resin is injected from one resin injection port into a cavity of a forming mold where two forming pins for forming the guide pin holes and a plurality of forming pins for forming the fiber hole are arranged in parallel to one another. A forming mold according to the present invention is provided with a cavity where a plurality of forming pins can be arranged in parallel to one another, and one resin injection port through which melted material resin can be injected into the cavity.

### TECHNICAL FIELD

The present invention relates to a method for manufacturing an optical connector ferrule and a forming mold used for manufacturing an optical connector ferrule.

### BACKGROUND OF THE INVENTION

An optical connector ferrule (hereinafter, referred to as “ferrule”) is one of optical components in order to connect optical fibers to each other or connect an optical fiber to an optical device. One example of such a ferrule will be shown in FIG. 3. This ferrule has an insertion or plug opening B into which optical fibers A are inserted, and guide pin holes E are formed on both sides of the insertion hole B. A plurality of guide grooves C for guiding the optical fibers A which have been inserted from the insertion opening B are arranged so as to run parallel to each other ahead of the insertion opening B. Fiber holes D through which the optical fibers A which have been guided by the guide grooves C pass are arranged ahead of the respective guide grooves C.

A main trend in a manufacturing method of such a ferrule as shown in FIG. 3 is a mold forming using plastic material resin in view of mass-productivity, manufacturing cost and the like. As shown in FIG. 4, for example, fused resin is injected in a cavity G in a forming mold F in which forming pins H for forming the guide pins E and forming pins J for forming the fiber holes D are arranged so as to run parallel with each other at predetermined intervals. Particularly, the resin is injected in the cavity G from two resin injection ports K formed on both transversely opposite sides outside the forming pins H, J. However, in a case that a ferrule is manufactured in the above manner, there occur the following problems.

(1) A positional accuracy and a dimensional accuracy in a micron range are required for each fiber hole D (FIG. 3) through which a very fine optical fiber A passes. However, the resin material which has been injected from the resin injection ports K shown in FIG. 4 flows in a direction shown with an arrow within the cavity G to fill in the cavity G. Therefore, there occurs a case that the material resin flowing within the cavity G strikes or collides on the forming pins H, J to apply an partially excessive force onto the forming pins H, J. As a result, bending and/or position shift occurs in the forming pins H, J. In particular, such bending or position shift occurs more easily in the fine forming pin J having a diameter smaller than that of the forming pin H so that it becomes difficult to form the fiber holes D with a required accuracy.

(2) The material resin which has been injected in the cavity G from the resin injection ports K shown in FIG. 4 spreads in the cavity G in such a manner as shown with oblique lines shown in any one of 5A to 5D. Accordingly, as shown in FIGS. 6A and 6B, a weld line L (a trace remaining after two currents of material resin which have been injected from the two resin injection ports K strike on each other and join finally) occurs in a formed ferrule. What is worse, the weld line L is easier to occur in the vicinity of a portion where the fiber holes D are formed and which requires high positional accuracy and high dimensional accuracy. When the weld line L occurs in the vicinity of the portion where the fiber holes D are formed, a uniform shrinking of the material resin is injured, a transcription of the forming pins J (FIG. 4) is lowered and the positional accuracy and the dimensional accuracy of the fiber holes D are reduced.

(3) The problems of the above (1) and (2) become remarkable in a case of an injection molding where material resin with a high viscosity is injected into cavity at a high velocity and with large pressure.

### SUMMARY OF THE INVENTION

An object of the present invention is to solve the various problems above.

A method for manufacturing an optical connector ferrule according to the present invention is a method for manufacturing an optical connector ferrule where a plurality of fiber holes are arranged between two guide pin holes, comprising the steps of: arranging two forming pins for forming the guide pin holes and a plurality of forming pins for forming the fiber holes in a cavity of a mold so as to run parallel to one another; and injecting melted material resin into the cavity from one resin injection port formed in the cavity. The resin injection port may be formed on flat face with the maximum area of respective flat faces of the cavity. The resin injection port maybe formed at a central portion, in an alignment direction of the forming pins, of the flat face. In either case, it is preferable that the fusion viscosity of the material resin injected from the resin injection port into the cavity is 300 Pa·sec or more. Here, Pa·sec (Pascal second) is a unit representing viscosity of liquid (here, material resin), and 1.10 Pa·sec is 1 dyn. S/cm². 1 poise. When there is a portion of liquid which has a flow velocity different from that of the remaining portion of the liquid, a shear stress acts on a boundary between the portion of liquid and the remaining portion of liquid, and the magnitude of the shear stress is proportional to the area of the boundary face and the velocity gradient in a direction perpendicular to the boundary. The coefficient at this time is a coefficient of viscosity.

A forming mold according to the present invention is a forming mold for forming an optical connector ferrule where a plurality of fiber holes are arranged, comprising a cavity where two forming pins for forming the guide pins can be arranged and the plurality of fiber holes can be arranged between the two forming pins; and one resin injection port through which fused material resin can injected in the cavity. The resin injection port may be formed on a flat face with the maximum area of respective flat faces forming the cavity. Also, the resin injection port may be formed on a central portion, in an alignment direction of the forming pins, of the flat face.

### BRIEF DESCRIPTION OF THE DRAWINGS

FIG. 1A is a plan view showing one example of a cavity formed in a mold of the present invention, and FIG. 1B is a side view of the one example;

FIGS. 2A to 2D are explanatory diagrams showing steps where material resin which has been injected in the cavity shown in FIGS. 1A and 1B spreads in the cavity;

FIG. 3 is a perspective view showing one embodiment of an optical connector ferrule;

FIG. 4 is a plan view showing one example of a conventional mold;

FIGS. 5A to 5D are explanatory diagrams showing steps where material resin which has been injected in the cavity shown in FIG. 4 spreads in the cavity;

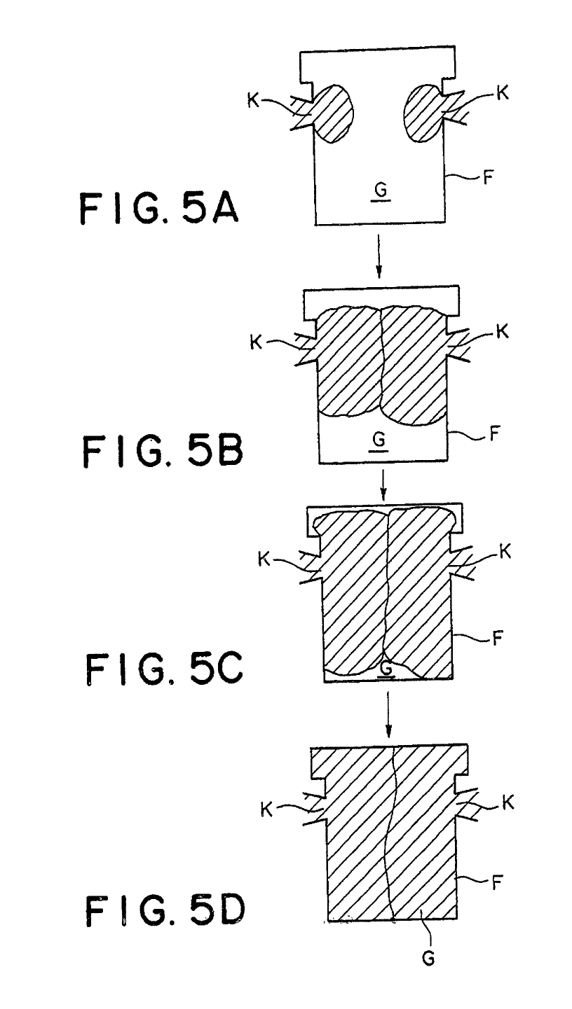

FIG. 6A is a plan view showing an optical connector ferrule where a weld line occurs, and FIG. 6b is a front view of the optical connector ferrule shown in FIG. 6A; and

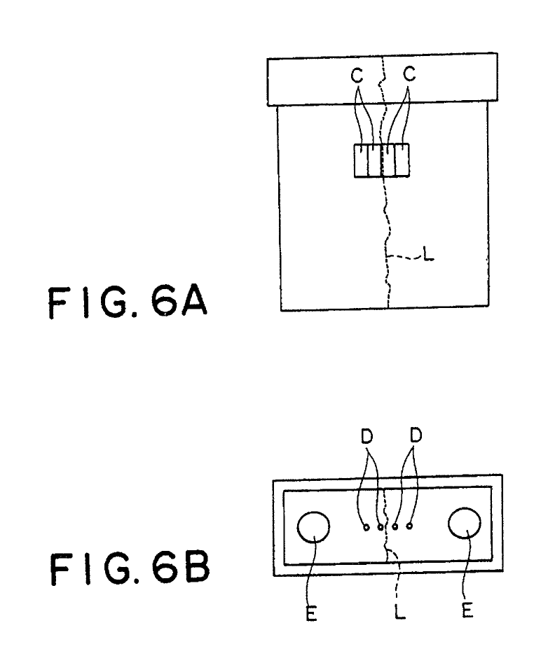

FIG. 7 is a graph showing a relationship between shear velocity and fusion viscosity of material resin.

### PREFERRED EMBODIMENT OF THE INVENTION

[First Embodiment]

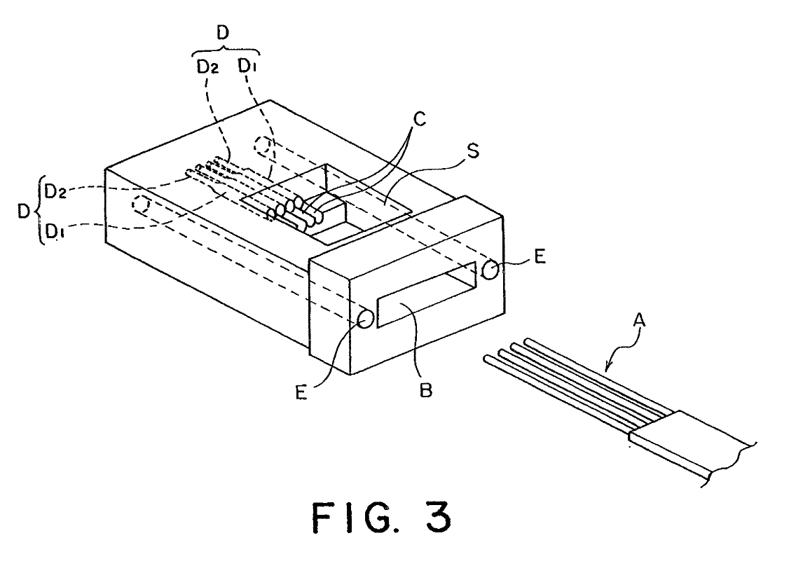

One embodiment of a method for manufacturing an optical connector ferrule according to the present invention and a forming mold according to the present invention will be explained below. The method for manufacturing an optical connector ferrule of the present invention, which will be explained below, is a method for manufacturing an optical connector ferrule shown in FIG. 3 (hereinafter, referred to as “ferrule”) using the mold of the present invention.

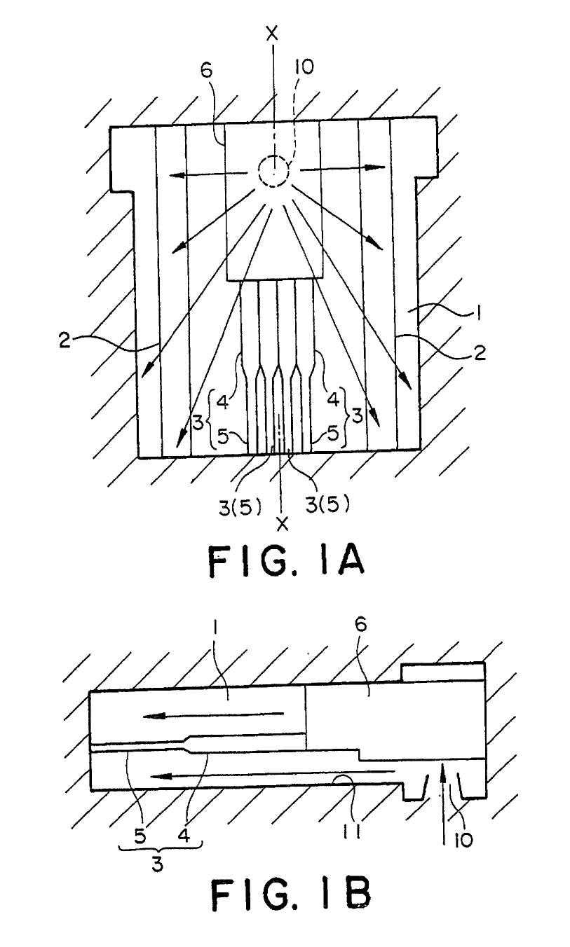

The mold of the present invention comprises an upper mold and a lower mold, and when the upper and lower molds are caused to butt on each other, a cavity 1 as shown in FIGS. 1A and 1B is formed therebetween. In the cavity 1, two forming pins 2 for forming guide pin holes E shown in FIG. 3 can be arranged in parallel to each other at a predetermined pitch. Also, a plurality of forming pins 3 for forming fiber holes D shown in FIG. 3 can be arranged between the forming pins 2 at a predetermined pitch in parallel to one another. Here, the fiber holes D shown in FIG. 3 comprises large diameter holes D₁ communicating with guide grooves C and fine holes D₂ communicating with the respective large diameter holes D₁. Each fine hole D₂ is a hole through which a tip end portion of each optical fiber A from which a cover is removed passes, and each large diameter hole D, is a hole through which a covered portion of the optical fiber A which is contiguous to the cover-removed portion passes. Accordingly, the forming pin 3 shown in FIGS. 1A and 1B has a structure where a small diameter portion 5 for forming the fine hole D₂ is formed in a continuous manner to the large diameter portion 4 for forming the large diameter hole D₁ ahead thereof. When the forming pins 3 having such a structure are arranged in the cavity 1, end portions of the forming pins 3 positioned near the large diameter portions 4 are supported by a core 6, and end portions thereof positioned near the small diameter portions 5 are caused to project outward from the cavity 1, and the projecting end portions are supported from below by V-shaped grooves (not shown). When the forming pins 2 for forming the guide pins E are arranged in the cavity 1, both end portions of the guide pins E are caused to project from the cavity 1, the projecting both end portions are supported from below by V-shaped grooves. Incidentally, the core 6 supporting the end portions of the forming pins 3 plays a role for forming an insertion opening B and a bonding agent filling space S.

As shown in FIGS. 1A and 1B, the cavity 1 is formed with a resin injection port 10 which communicates with the outside and through which melted material resin can be injected into the cavity 1. The resin injection port 10 is formed by only one in one of the upper and lower molds which has a flat face with the maximum area. The resin injection port 10 preferably meets at least one of the following conditions (1) to (4), more preferably more conditions.

(1) The resin injection port exists on the flat face 11 with the maximum area of the respective flat faces constituting the cavity 1.

(2) The resin injection port exists on the central line X-X of alignment direction of the forming pins 3.

(3) The resin injection port exists outside the forming pins 3 in an axial direction of the forming pins 3 (in detail, nearer to the core 6 than the forming pins 3),

(4) The resin injection port has a shape which is divided into two symmetrical halves by the central line X-X. It is preferable that respective halves obtained by dividing the shape by the central line X-X are symmetrical semi-circles.

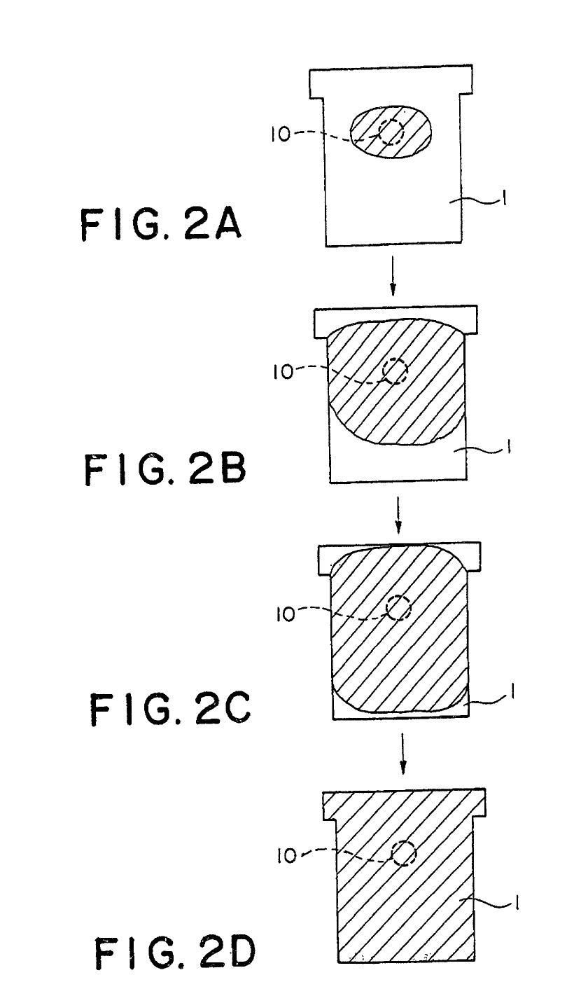

The material resin which has been injected from the resin injection port 10 shown in FIGS. 1A and 1B into the cavity 1 flows in the cavity 1 as shown with arrows in these figures. Particularly, the material resin flows radially centering on the resin injection port 1. Therefore, the material resin which has been injected from the resin injection port 10 will spread in the cavity 1 in such a manner as shown with oblique lines in FIGS. 2A to 2D to fill in the cavity 1. As a result, the material resin flowing in the cavity 1 (spreading in the cavity 1) is prevented from applying partially excessive force on the forming pins 2, 3, so that such a possibility can considerably be reduced that bending and/or position shift occur in the forming pins 2, 3. Furthermore, since such a configuration is not employed in this embodiment that resin materials injected from different two or more positions strike on each other, any weld line does not occur in a molded ferrule.

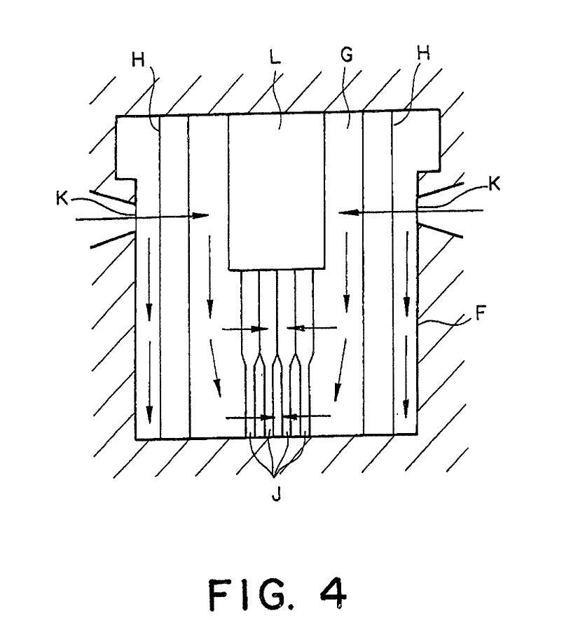

Results of an experiment which was made in order to confirm that any weld line did not occur will be shown in Table 1 and Table 2. Table 1 is a table showing a relationship between fusion viscosity of material resin and presence/absence of weld line occurrence in a case that the ferrule shown in FIG. 3 is molded using the mold (having two resin injection ports K) shown in FIG. 4. Table 2 is a table showing a relationship between fusion viscosity of material resin and presence/absence of weld line occurrence in a case that a ferrule similar to the above ferrule is molded using the forming mold of the present invention. Incidentally, in both the former case and the latter case, the temperatures of the resin materials were set to the same arbitrary temperature and the forming molds used were set to the same arbitrary temperature, respectively.

TABLE 1

| FUSION VISCOSITY | | | | | | | |
|---|---|---|---|---|---|---|---|
| (Pa · sec) | 200 | 300 | 400 | 500 | 1000 | 1190 | 1260 |
| Presence/absence | Absence | Absence | Absence | Absence | Absence | presence/ | Molding |
| of weld line | | | | | | absence | impossible |

TABLE 2

| FUSION VISCOSITY | | | | | | | |
|---|---|---|---|---|---|---|---|
| (Pa.sec) | 200 | 300 | 400 | 500 | 1000 | 1190 | 1260 |
| Presence/absence | Absence | Absence | Absence | Absence | Absence | Absence | Molding |
| of weld line | | | | | | | impossible |

From Table 1 and Table 2, it will be understood that there is the following difference between the case that the material resin has been injected into the cavity from two different positions and the case that the material resin has been injected into the cavity from one position (the present invention case).

In the former case, when the fusion viscosity of the material resin is 1000 pa·sec, there occur both a case that a weld line occurs in the molded ferrule and a case that no weld line occurs therein. When the fusion viscosity is 1190 pa·sec or more, a weld line occurs securely.

In the latter case, any weld line does not occur in a molded ferrule irrespective of the fusion viscosity of the material resin.

From Table 1, it will be understood that, even when material resin is injected into a cavity from two positions, a weld line can be prevented from occurring by lowering the fusion viscosity of the material resin. However, it is actually difficult to prevent occurrence of a weld line by lowering the fusion viscosity of material resin. This is because, when a ferrule is shrunk due to change in environmental temperature or the like, the transmission quality of an optical fiber fixed to the ferrule is adversely affected. Therefore, the ferrule must be reduced in shrinkage due to temperature change as much as possible. However, since material resin with low shrinkage becomes high filler when fusion viscosity is lowered, the fusion viscosity can not be lowered.

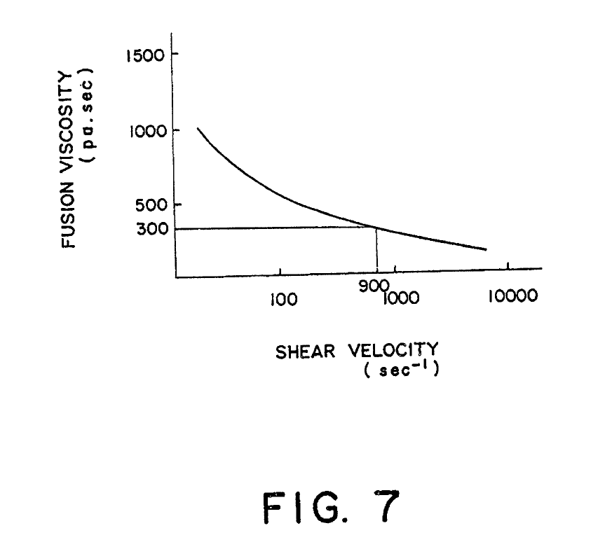

There is a method where occurrence of a weld line is prevented by increasing the temperature of a mold. However, when the temperature of the mold is raised (when the molding temperature is raised), shrinking of the ferrule after molded is increased, thereby making it difficult to mold a ferrule with a high accuracy. As shown in FIG. 7, in a case of an ordinary material resin used for molding a ferrule, the higher the shear rate, the lower the fusion viscosity.

In the above, for explaining the method for manufacturing an optical connector ferrule according to the present invention, the case where the ferrule shown in FIG. 3 is manufactured has been explained as an example. However, it is also possible to manufacture a ferrule other than the ferrule shown in FIG. 3. Also, even when a ferrule other than the ferrule shown in FIG. 3 has been manufactured, the same operations and effects as the above can be obtained. Particularly, a ferrule which has fiber holes and/or guide pin holes with a high dimensional accuracy and a high positional accuracy and where there is no weld line can be manufactured.

Effect of the Invention

The method for manufacturing an optical connector ferrule according to the present invention can achieve one or more of the following effects (1) to (4).

(1) Since material resin is injected into a cavity from one resin injection port, the material resin injected spreads radially centering on the resin injection port. Accordingly, such a possibility is remarkably reduced that forming pins arranged in a cavity bend, and positional shift thereof occurs due to application of eccentric force on the forming pins. As a result, an optical connector ferrule with a high dimensional accuracy and a high positional accuracy can be manufactured.

(2) Since material resin is injected into a cavity from one resin injection port, such a phenomenon does not occur that two currents of material resin injected from two different positions strike on each other. Accordingly, an optical connector ferrule which does not include a weld line can be manufactured.

(3) Since material resin is injected from one of the following two resin injection ports, the above effect is further secured. One is a port provided on a flat face with the maximum area of respective flat faces of the cavity and the other is a port provided on the flat face and at a center of alignment direction of the forming pins.

(4) Since the fusion viscosity of material resin injected into a cavity is 300 Pa·sec or more, the above effect is further secured.

The forming mold according to the present invention can achieve one or more of the following effects (1) to (4).

(1) Since only one resin injection port for injecting material resin into a cavity is formed, the material resin injected spreads radially centering on the resin injection port. Accordingly, such a possibility is remarkably reduced that forming pins arranged in a cavity bend, and positional shift thereof occurs due to application of eccentric force on the forming pins. As a result, an optical connector ferrule with a high dimensional accuracy and a high positional accuracy can be manufactured.

(2) Since only one resin injection port for injecting material resin into a cavity is formed, such a phenomenon does not occur that material resins injected from two different positions strike on each other. Accordingly, an optical connector ferrule which does not include a weld line can be manufactured.

(3) A resin injection port is formed on a central line of alignment direction of the forming pins arranged in the cavity. Accordingly, the above effect is further secured.

(4) A resin injection port is formed on a flat face with the maximum area of respective flat faces of a cavity. Accordingly, the above effect is further secured.

What is claimed is

1. A method for manufacturing an optical connector ferrule where a plurality of fiber holes are arranged between two guide pin holes, comprising the steps of: arranging two forming pins for forming the guide pin holes and a plurality of forming pins for forming the fiber holes in a cavity of a forming mold so as to be parallel to one another; and injecting melted material resin into the cavity from one resin injection port formed in the cavity.

2. A method for manufacturing an optical connector ferrule where a plurality of fiber holes are arranged between two guide pin holes, comprising the steps of: arranging two forming pins for forming the guide pin holes and a plurality of forming pins for forming the fiber holes in a cavity of a forming mold in parallel to one another; and injecting melted material resin into the cavity from one resin injection port which is formed on a flat face with the maximum area of respective flat faces of the cavity.

3. A method for manufacturing an optical connector ferrule where a plurality of fiber holes are arranged between two guide pin holes, comprising the steps of: arranging two forming pins for forming the guide pin holes and a plurality of forming pins for forming the fiber holes in a cavity of a forming mold in parallel to one another; and injecting melted material resin into the cavity from one resin injection port formed on a flat face with the maximum area of respective flat faces of the cavity and at a center of alignment direction of the forming pins.

4. A method for manufacturing an optical connector ferrule according to any one of claims 1 to 3, wherein fusion viscosity of the material resin injected into the cavity is 300 Pa·sec or more.

5. A forming mold used for molding an optical connector ferrule where a plurality of fiber holes are arranged between two guide pin holes, comprising: a cavity where two forming pins for forming the guide pin holes are arranged in parallel to each other at a predetermined interval and a plurality of forming pins for forming the fiber holes can be arranged in parallel to one another between the two forming pins; and one resin injection port through which melted material resin can be injected into the cavity.

6. A forming mold used for molding an optical connector ferrule where a plurality of fiber holes are arranged between two guide pin holes, comprising: a cavity where two forming pins for forming the guide pin holes are arranged in parallel to each other at a predetermined interval and a plurality of forming pins for forming the fiber holes can be arranged in parallel to one another between the two forming pins; and one resin injection port through which melted material resin can be injected into the cavity, wherein the resin injection port is formed on a flat face with the maximum area of respective flat faces forming the cavity.

7. A forming mold used for molding an optical connector ferrule where a plurality of fiber holes are arranged between two guide pin holes, comprising: a cavity where two forming pins for forming the guide pin holes are arranged in parallel to each other at a predetermined interval and a plurality of forming pins for forming the fiber holes can be arranged in parallel to one another between the two forming pins; and one resin injection port through which melted material resin can be injected into the cavity, wherein the resin injection port is formed on a flat face with the maximum area of respective flat faces forming the cavity and at a center of alignment direction of the forming pins.
